(19) United States
(12) Patent Application Publication
(10) Pub. No.: US 2005/0013213 A1
(43) Pub. Date: Jan. 20, 2005

(54) Objective lens driving apparatus for an optical head

(75) Inventor: Masayuki Fujita, Tokyo (JP)

Correspondence Address: FOLEY AND LARDNER;SUITE 500, 3000 K STREET NW, WASHINGTON, DC, 20007, US

(73) Assignee: NEC CORPORATION

(21) Appl. No.: 10/889,119

(22) Filed: Jul. 13, 2004

(30) Foreign Application Priority Data
Jul. 14, 2003 (JP) 2003-273840

(51) Int. Cl. G11B 7/00

(52) U.S. Cl. 369/44.15; 369/44.22

(57) ABSTRACT

An objective lens driving apparatus for an optical head is disclosed which exerts a high thrust in focusing and radial directions with reduced power consumption and suppresses vibration by a rolling mode of a lens holder even when a focused position of an objective lens is shifted thereby to achieve a good reproduction characteristic. Each of a pair of magnets for forming magnetic fields necessary for causing a focusing coil and tracking coils to generate electromagnetic forces is magnetized so as to have three poles including a centrally located N pole and a pair of opposite side S poles in the radial or tracking direction. Each of the tracking coils is disposed such that the two opposite sides thereof in the radial direction are opposed separately to the N and S poles so that a thrust or electromagnetic force of a magnitude substantially equal to twice is generated in the radial direction. The permanent magnets have a length in the direction of the optical axis greater than that of the tracking coil so that the magnetic intensity is uniformed and the rolling mode of the objective lens is suppressed. The boundary portions of the three poles are positioned on the outer sides of yokes so that the thrust (or electromagnetic force for the focusing coil is increased.

### BACKGROUND OF THE INVENTION

1. Field of the Invention

The present invention relates to an objective lens driving apparatus for driving an objective lens provided on an optical head for recording or reproducing information on or from an optical disk medium, and more particularly to saving of the power and suppression of resonance of an objective lens by a rolling mode in an object lens driving apparatus of the type described.

2. Description of the Related Art

An optical disk apparatus which uses an optical disk medium such as a CD (Compact Disk) or a DVD (Digital Versatile Disk) usually includes an optical head for condensing a laser beam emitted from a laser light source such as a semiconductor laser on an information recording surface of an optical disk medium by means of an objective lens to record, reproduce and erase information on and from the information recording surface. In an optical disk apparatus of the type described, the track position on the recording surface of the medium on which information is recoded normally fluctuates in the direction of an optical axis which is the thicknesswise direction of the optical disk medium (in the present specification, the direction coincides with a focusing direction) and a radial direction which is the direction of a radius of the optical disk medium (in the present specification, the direction coincides with a tracking direction) due to surface wobbling, eccentricity and so forth of the optical disk medium upon rotation. Therefore, in the optical disk apparatus, it is necessary for the objective lens to be driven to an optimum position and follow up a desired track. To this end, an objective lens driving apparatus for driving the optical head and hence the objective lens in the direction of the optical axis and the radial direction, or in other words, in a focusing direction and a tracking direction, is provided.

FIG. 10 shows an appearance of an example of a conventional objective lens driving apparatus. Referring to FIG. 10, an objective lens 1 is supported on a lens holder 2 and disposed below an optical disk medium D indicated by an imaginary line. The lens holder 2 is supported in a cantilever fashion on a frame 4 for an optical head by supporting members 5 each in the form of resiliently deformable rod and can be moved in a direction of an optical axis and a radial direction as described hereinabove. The lens holder 2 is disposed between a pair of permanent magnets 6 disposed on the opposite sides thereof in a direction perpendicular to the radial direction. A focusing coil 8 is wound around the lens holder 2, and a pair of tracking coils 9 are disposed on the opposite end faces of the lens holder 2 opposing to the permanent magnets 6. It is to be noted that an optical head base having yokes provided integrally thereon for supporting the frame 4 and raising the magnetic flux density of the permanent magnets 6 is not shown in FIG. 10.

In the objective lens driving apparatus having the configuration described above, since the focusing coil 8 and the tracking coils 9 are disposed in magnetic fields generated by the permanent magnets 6, if the focusing coil 8 is energized, then the lens holder 2 is moved in the direction of the optical axis by electromagnetic force generated by the focusing coil 8, that is,by electromagnetic force according to the Fleming's left hand rule. On the other hand, if the tracking coils 9 are energized, then the lens holder 2 is moved in a radial direction by electromagnetic force generated by the tracking coils 9 similarly. Consequently, the objective lens 1 can be adjusted in position in the direction of the optical axis and the radial direction.

Incidentally, in recent years, as increase of the speed of operation of computers proceeds, there is a tendency that also the recording and reproduction speeds required for optical disk apparatus increase. In order to increase the speed of operation of an optical disk apparatus, it is necessary to raise the speed of rotation of an optical disk medium to allow high speed recording and reproduction of information. In this instance, even if the speed of rotation of the optical disk increases, it is necessary for the objective lens to follow up tracks on the optical recording medium, on which information is recorded, on the real-time basis. Therefore, in order to raise the speed of the optical disk apparatus, it is necessary to raise the thrust of the objective lens driving apparatus to be generated when the objective lens is to be driven in the radial direction. Since the objective lens is driven by the thrust provided by electromagnetic force, then the electromagnetic force can be increased by increasing the voltage or electric current to be supplied to the tracking coil. This, however, increases the power consumption of the optical disk apparatus.

As a countermeasure for the problem just described, it is a possible idea to apply an apparatus disclosed in Japanese Patent Laid-Open No. 2002-245647 (hereinafter referred to as Patent Document 1) to reduce the power consumption. According to the apparatus disclosed in the Patent Document 1, a tracking coil is wound in a shape proximate to a rectangular shape and disposed such that different halves thereof in the direction of an optical axis, that is, upper and lower halves thereof, are opposed to different magnetic poles such that one of the halves is opposed to the N pole of a magnet and the other half is opposed to the S pole of the magnet.

Since the apparatus is configured in such a manner as described above, when the tracking coil is energized, electromagnetic forces in the same direction (rightward or leftward direction) are generated on the opposite sides of the tracking coil. Consequently, high electromagnetic force can be obtained with low current.

Although it is possible to adopt the apparatus of the Patent Document 1 only if it is intended to reduce the power consumption, it is difficult to solve the following problem.

In particular, an optical disk has been proposed recently which incorporates a single objective lens and two laser light sources having different wavelengths such that it can record, reproduce and erase information on and from optical disk media having different thicknesses from each other such as a CD and a DVD. In an optical disk apparatus of the type just described, since the height of the information recording surface and the thickness of a glass cover differ among different optical disk media, it is necessary to shift the focused position in the direction of an optical axis of a laser beam condensed by the objective lens. In this instance, if the focused position in the direction of the optical axis of the objective lens fluctuates, or in other words, if the position in the direction of the optical axis of the lens holder which supports the objective lens thereon fluctuates, then also the position of the tracking coil is fluctuated integrally thereby in the direction of the optical axis.

Conventionally, in order that desired electromagnetic force in the tracking direction may be obtained even with low electric current, the tracking coil is normally formed such that the sides thereof extending in the direction of the optical axis are elongated as much as possible, and usually, the length of the sides is set substantially equal to the length of the permanent magnet in the direction of the optical axis. On the other hand, the permanent magnet has a characteristic that the magnetic field intensity varies along the direction of the optical axis. Therefore, if the tracking coil is moved in the direction of the optical axis (in the upward or downward direction) together with the lens holder as described above, then since the upper and lower halves of the tracking coil in the apparatus of the Patent Document 1 are opposed to the different magnetic poles as described hereinabove, the opposing area to the N pole and the opposing area to the S pole become different from each other in the upward and downward direction, and this occurs with the left and right tracking coil portions. This displaces the central point of the electromagnetic forces generated by the tracking coils along the direction of the optical axis and gives rise to a problem that resonance by rolling that, when the tracking coils and hence the lens holder performs a tracking movement and a focusing movement, it performs tilting movements, which makes it difficult to obtain good recording and reproduction characteristics on an optical disk medium.

### SUMMARY OF THE INVENTION

It is an object of the present invention to provide an objective lens driving apparatus for an optical head which exerts a high thrust in a radial or tracking direction without increasing the power consumption of an optical disk apparatus to achieve good recording and reproduction characteristics of information.

It is another object of the present invention to provide an objective lens driving apparatus for an optical head which suppresses vibration by a rolling mode of a lens holder even when the objective lens is moved in a direction of an optical axis or in a focusing direction thereby to achieve good recording and reproduction characteristics of information.

It is a further object of the present invention to provide an objective lens driving apparatus for an optical head which can exert a high thrust in a direction of an optical axis.

In order to attain the objects described above, according to the present invention, there is provided an objective lens driving apparatus for an optical head, comprising a rockable lens holder on which an objective lens for condensing light from a light source on an optical disk medium, a focusing coil for driving the objective lens in a direction of an optical axis of the objective lens and a tracking coil for driving the objective lens in a radial direction perpendicular to the optical axis are carried, and a magnet for cooperating with the focusing coil and the tracking coil to generate electromagnetic forces in the direction of the optical axis and the radial direction, the magnet having a first magnetic pole centrally located thereon along the radial direction and a pair of second magnetic poles having a different polarity from that of the first magnetic pole and located on the opposite sides of the first magnetic pole, the tracking coil including a pair of elements disposed separately in the radial direction in an opposing relationship to both of the first and second magnetic poles at boundary portions between the first and second magnetic poles of the magnet.

With the objective lens driving apparatus, the following advantages can be achieved.

First, since the thrust in the tracking direction can be increased by the electromagnetic force exerted between the second magnetic poles having the different polarity from that of the first magnetic pole of the magnet and the tracking coil in addition to the electromagnetic force exerted between the first magnetic pole and the tracking coil, the thrust in the tracking direction can be improved without increasing the power consumption.

Second, since the tracking coil is opposed separately in the radial direction to both of the first magnetic pole and the second magnetic poles of the magnet separated from each other in the radial direction as different from the conventional objective lens driving apparatus of the Patent Document 1 wherein the tracking coil is opposed separately at upper and lower halves thereof in the direction of the optical axis (upward and downward direction) to the N pole and the S pole of the magnet disposed separately in the direction of the optical axis, even if the tracking coil is displaced upon shifting of the objective lens in the direction of the optical axis, the central point of the thrust which is generated in the tracking coil is less liable to be fluctuated in the direction of the optical axis. Consequently, even if the focused position of the objective lens is shifted, vibration of the lens holder by a rolling mode can be suppressed.

Preferably, the first magnetic pole of the magnet has a dimension in the radial direction greater than the dimension in the radial direction of a yoke disposed in an opposing relationship across the focusing coil, and the second magnetic poles on the opposite sides of the first magnetic pole are positioned on the outer sides with respect to the opposite side edges of the yoke in the radial direction.

With the objective lens driving apparatus, the number of magnetic fluxes which pass across the focusing coil increases, and consequently, the thrust in the focusing direction can be improved without increasing the power consumption.

Preferably, each of the second magnetic poles of the magnet in the radial direction has a dimension smaller than the dimension of the first magnetic coil in the radial direction, and the elements of the tracking coil opposing to the second magnetic poles have a second opposing area smaller than a first opposing area of the elements of the tracking coil opposing to the first magnetic pole.

With the objective lens driving apparatus, increase of the dimension of the magnet in the radial direction can be minimized to achieve increase of the thrust in the tracking direction.

Preferably, the elements of the tracking coil are wound in a substantially quadrangular shape, and the two opposite sides from among the four sides of the elements of the tracking coil which extend in the direction of the optical axis are opposed to the first and second magnetic poles of the magnet.

With the objective lens driving apparatus, the dimension of the second magnetic poles of the magnet in the radial direction can be minimized.

Preferably, the magnet is open at the opposite end faces thereof in the direction of the optical axis in order to maintain the symmetry of the magnetic intensity distribution.

More preferably, the tracking coil is disposed in an opposing relationship to a substantially central position of the magnet in the direction of the optical axis in order to normally uniform the magnetic intensity between the tracking coil and the magnet.

Preferably, the magnet has a dimension in the direction of the optical axis equal to or greater than twice an effective length dimension of a portion of the tracking coil which extends in a direction parallel to the direction of the optical axis in order that the electromagnetic force by the tracking force may be exerted uniformly in the direction of the optical axis.

The magnet may be formed from a single magnetic member magnetized so as to have the first and second magnetic poles or alternatively from a plurality of magnetic pieces integrated with each other and magnetized so as to have the first and second magnetic poles.

The above and other objects, features and advantages of the present invention will become apparent from the following description and the appended claims, taken in conjunction with the accompanying drawings in which like parts or elements are denoted by like reference symbols.

### BRIEF DESCRIPTION OF THE DRAWINGS

FIG. 1 is a schematic perspective view of part of an optical disk apparatus in which an objective lens driving apparatus according to the present invention is incorporated;

FIG. 2 is a perspective view showing, partly broken, the objective lens driving apparatus shown in FIG. 1;

FIG. 3 is an exploded perspective view of the objective lens driving apparatus of FIG. 2;

FIG. 4 is a plan view of the objective lens driving apparatus of FIG. 2;

FIG. 5 is a schematic sectional view taken along line A-A of FIG. 4;

FIG. 6 is a perspective view illustrating the directions of magnetic field distributions around a permanent magnet and a tracking coil of the objective lens deriving apparatus of FIG. 2;

FIG. 7 is a schematic view illustrating magnetic forces exerted by the tracking coil shown in FIG. 6;

FIGS. 8(a) and 8(b) are schematic plan views illustrating a relationship between and magnetic forces of the permanent magnet and a yoke shown in FIG. 6;

FIG. 9 is a schematic view illustrating a magnetic field intensity distribution in a focusing direction in the proximity of the tracking coil shown in FIG. 6; and

FIG. 10 is a perspective view of an example of a conventional objective lens driving apparatus.

### DESCRIPTION OF THE PREFERRED EMBODIMENT

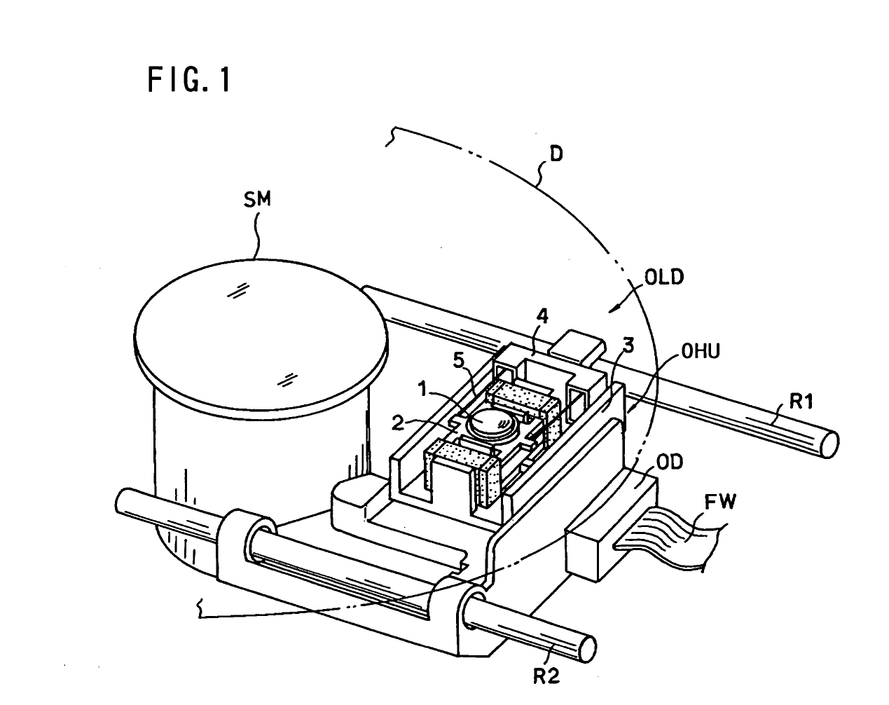

Referring to FIG. 1, there is shown an optical disk apparatus in which an objective lens driving apparatus to which the present invention is applied is incorporated. The optical disk apparatus includes a spindle motor SM for driving an optical disk medium D such as a CD indicated by an imaginary line to rotate at a high speed, and a pair of rails R1 and R2 extending in parallel along a radial direction of the spindle motor SM. An optical head unit OHU is supported on the rails R1 and R2 such that it can be moved back and forth in a radial direction of the optical disk medium D along the rails R1 and R2 by a driving mechanism not shown. An objective lens driving apparatus OLD to which the present invention is applied is carried on the optical head unit OHU, and also a light source section OD including a light emitting element such as a semiconductor laser and a light receiving element such as a light receiving diode is supported on the optical head unit OHU. A laser beam emitted from the light source section OD is projected on the optical disk medium D through the objective lens driving apparatus OLD, and the laser light reflected from the optical disk medium D is received by the light source section OD. Thus, an electric signal according to the received light signal is outputted from the light source section OD. The optical head unit OHU and the optical disk apparatus are electrically connected to each other by a flexible wiring cable FW.

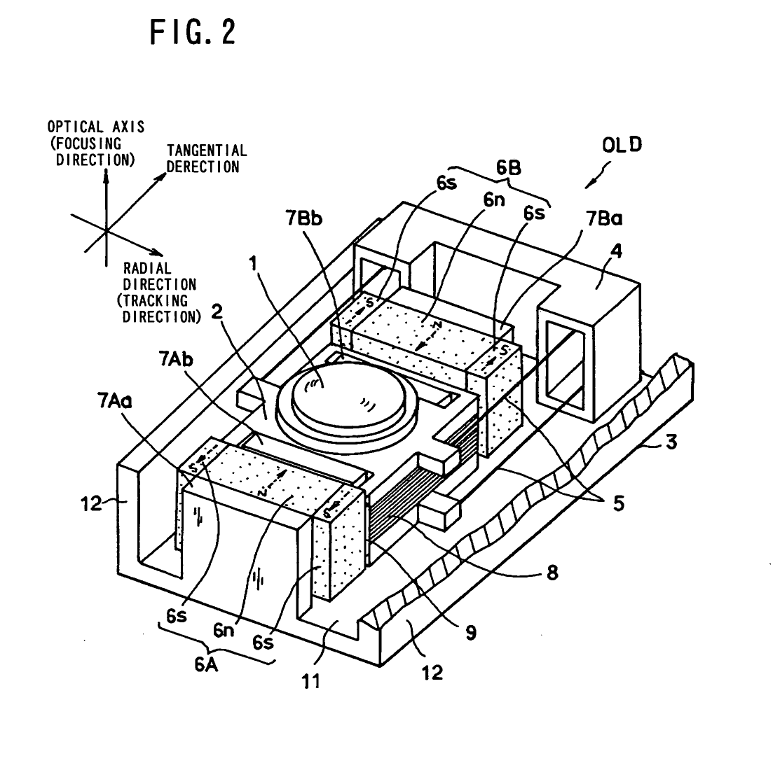

Referring now to FIG. 2, there is shown partly in section the objective lens driving apparatus OLD described above. The objective lens 1 is mounted on a lens holder 2 such that it condenses light from the light source section OD carried on the optical head unit OHU on an information recording surface of the optical disk medium D. The lens holder 2 is carried for rocking motion in the following manner on an optical head base 3. In particular, four supporting members 5 each in the form of a resilient rod are secured on one-end sides thereof to a frame 4 secured to the optical head base 3, and the lens holder 2 is supported in a cantilever fashion at the other ends of the supporting members 5 such that it can be moved in a direction of an optical axis (focusing direction) and a radial direction (tracking direction) while it keeps a posture by means of a parallel link mechanism formed from the supporting members 5. A hinge of a leaf spring or the like may naturally be used for the supporting members 5.

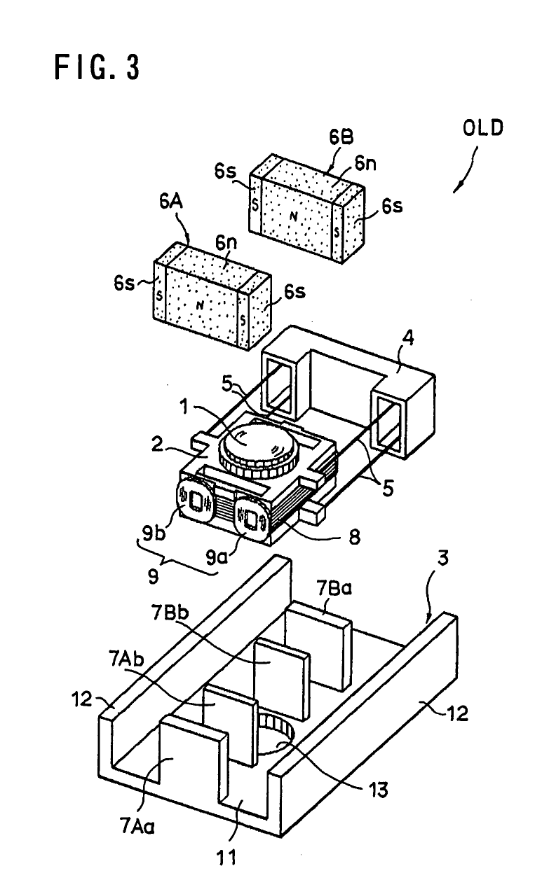

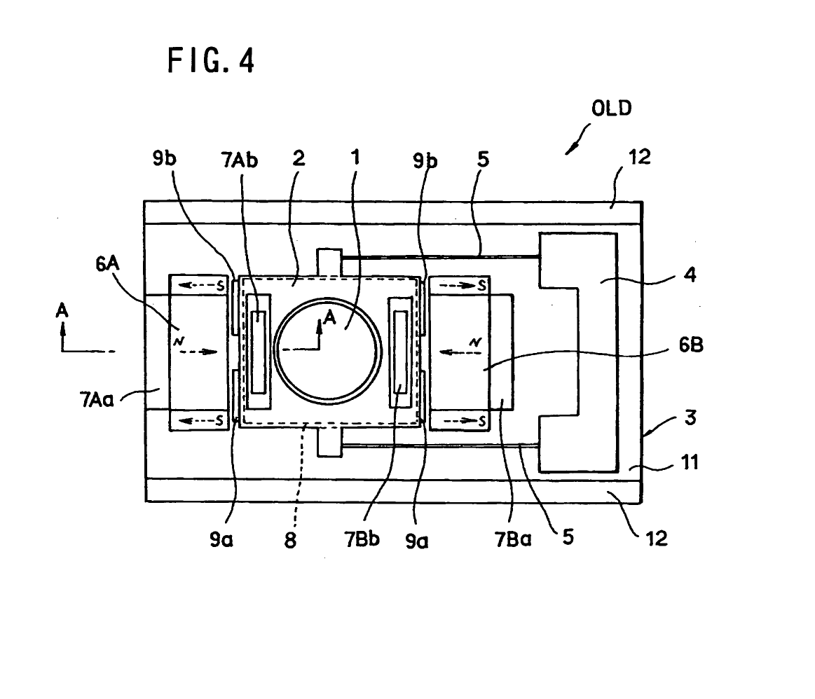

Referring also to FIG. 3, a pair of side walls 12 are formed on the opposite sides of a rectangular bottom wall 11 of the optical head base 3 in the radial direction. Four yokes wherein each two are paired with each other, that is, a first pair of yokes 7Aa and 7Ab and a second pair of yokes 7Ba and 7Bb, are mounted uprightly at required intervals in a tangential direction perpendicular to the radial direction (tracking direction) between the side walls 12 on the optical head base 3. A laser beam passing window 13 is perforated in the bottom wall 11 between the yokes 7Ab and 7Bb. Referring also to FIG. 4, a permanent magnet 6A is disposed between the first pair of yokes 7Aa and 7Ab while another permanent magnet 6B is disposed between the second pair of yokes 7Ba and 7Bb. The permanent magnets 6A and 6B are fixedly supported in a closely contacting relationship on inner faces of the yokes 7Aa and 7Ba, respectively. This configuration is effective to raise the distribution efficiency of the magnetic field intensity.

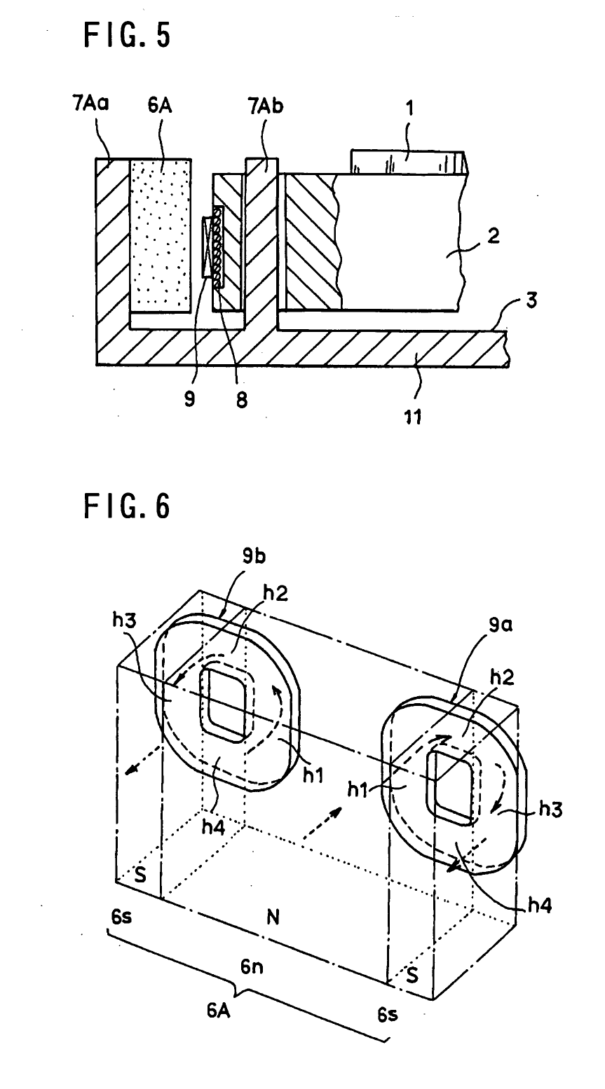

Referring particularly to FIG. 5, a gap into which part of the lens holder 2 can be inserted is secured between the permanent magnets 6A and 6B and the yokes 7Ab and 7Bb and a required distance is secured between lower end faces of the permanent magnets 6A and 6B and an upper face of the bottom wall 11 of the optical head base 3 such that the opposite end faces of the permanent magnets 6A and 6B in the direction of the optical axis are open.

Referring to FIGS. 1 to 4, the lens holder 2 is supported on the optical head base 3 by means of the four supporting members 5 and disposed between the paired permanent magnets 6A and 6B disposed in an opposing relationship to each other at a required distance in the tangential direction. Further, a focusing coil 8 and a pair of tracking coils 9 are mounted on the lens holder 2. The focusing coil 8 generates a thrust for driving the objective lens 1 in the direction of the optical axis so as to allow the objective lens 1 to follow up fluctuations in surface deflection and eccentricity of the optical disk medium D. The tracking coils 9 generate thrusts for driving the objective lens 1 in the radial direction.

The focusing coil 8 is wound in a horizontal direction around peripheral side faces of the lens holder 2. Particularly at locations of the lens holder 2 opposing to the permanent magnets 6A and 6B, the coil wire of the focusing coil 8 is extended in a horizontal direction with respect to the permanent magnets 6A and 6B. While only the tracking coil 9 on the side opposing to the permanent magnet 6A is shown in FIGS. 2 and 3, each of the tracking coils 9 on the opposite end faces including the tracking coil 9 on the opposite side opposing to the permanent magnet 6B is formed from two tracking coil elements 9a and 9b of the same specifications in the horizontal direction, that is, in the radial direction. The focusing coil 8 and the tracking coils 9 are disposed such that they extend at positions in magnetic fields generated by the permanent magnets 6A and 6B, that is, between the yokes 7Aa and 7Ab and between the yokes 7Ba and 7Bb, respectively. It is to be noted that the yokes can be omitted where the magnetic field intensities generated by the permanent magnets 6A and 6B are sufficiently high.

The permanent magnet 6A from between the paired permanent magnets 6A and 6B and the opposing tracking coil 9 are schematically shown in FIG. 6. Referring to FIG. 6, the permanent magnet 6A is magnetized so as to have three poles including a central N pole 6n formed with a comparatively great thickness in the radial direction and a pair of opposite side S poles 6s of a comparatively small width disposed on the opposite left and right sides of the N pole 6n. While the permanent magnet 6A is magnetized so as to have three poles in this manner, the tracking coil elements 9a and 9b of the tracking coil 9 are disposed such that the centers of the wound coils thereof are substantially opposed to the boundaries between the N pole 6n and the S poles 6s of the permanent magnet 6A. In particular, each of the tracking coil elements 9a and 9b wound in a rectangular or square configuration is disposed such that, from among four sides h1, h2, h3 and h4 thereof, the sides h1 and h3 on the opposite sides in the radial direction are opposed separately to the central N pole 6n and one of the opposite side permanent magnets 6. The paired tracking coil elements 9a and 9b of the tracking coil 9 opposing to the permanent magnet 6A are connected to an electric current source not shown such that the energization directions thereof are opposite to each other.

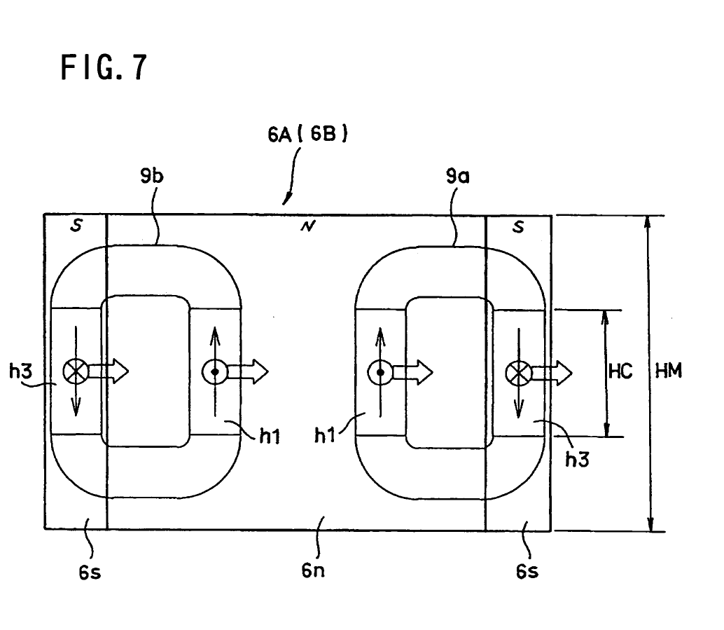

Referring particularly to FIG. 6, the lengths of the central N pole 6n and the opposite side S poles 6s of the permanent magnet 6A in the direction of the optical axis are determined such that the individual magnetic poles 6n and 6x extend continuously over the length region at least including the range within which the lens holder 2 is moved in the direction of the optical axis. Further, as seen from FIG. 7 in which an arrangement configuration of the side faces of the permanent magnet 6A and the tracking coils 9 is shown, the dimension HM of the permanent magnet 6A in the direction of the optical axis is sufficiently longer than the length of the tracking coil 9 in the direction of the optical axis, particularly the dimension HC (hereinafter referred to as effective length dimension of the tracking coil 9 in the direction of the optical axis) of the sides h1 and h3 parallel to the direction of the optical axis. Particularly in the present embodiment, the dimension HM is substantially equal to twice the dimension HC. This similarly applies to the permanent magnet 6B.

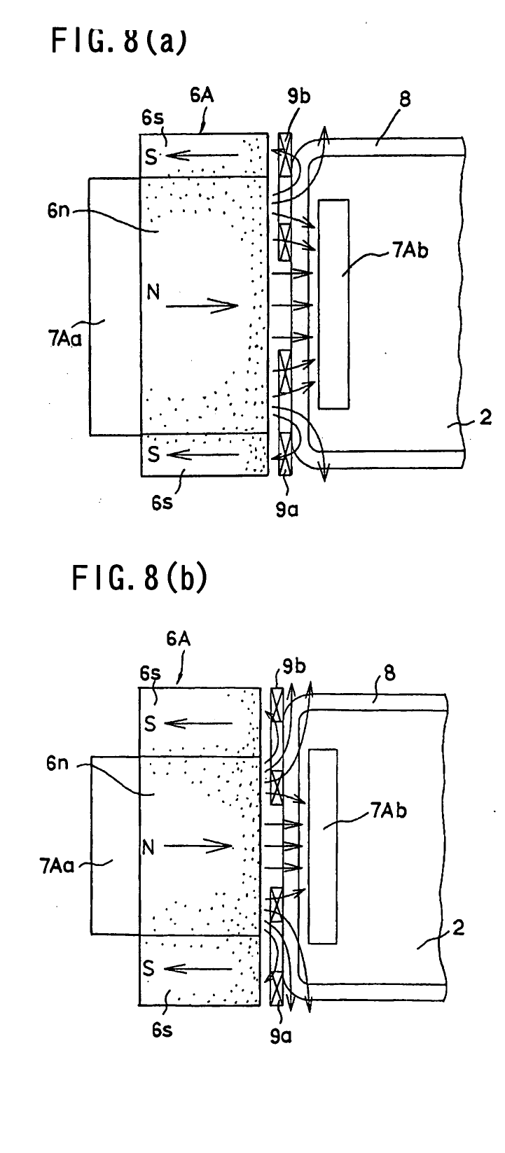

Referring to FIG. 8(a), an arrangement configuration of the side faces of the permanent magnet 6A, opposing tracking coil 9 and focusing coil 8. The boundaries between the N pole 6n and the S poles 6s on the opposite sides of the N pole 6n of the permanent magnet 6A are positioned on the opposite outer sides with respect to the opposite side edge portions of the center side yoke 7Ab in the radial direction. Also with regard to the permanent magnet 6B, the boundaries between the N pole 6n and the S poles 6s on the opposite sides of the N pole 6n are positioned on the outer sides with respect to the opposite side edge portions of the center side yoke 7Bb in the radial direction.

Operation of the optical disk apparatus having the configuration described above is described. Since each of the paired permanent magnets 6A and 6B disposed in an opposing relationship to each other in the tangential direction is magnetized so as to have the three poles including the central N pole 6n and the opposite side S poles 6s, a magnetic field from the central N pole 6n toward the opposite side S poles 6s is generated. In this state, since the focusing coil 8 is disposed in the magnetic fields of the permanent magnets 6A and 6B on the opposite end faces of the lens holder 2 in the tangential direction, if the focusing coil 8 is energized, then electromagnetic force in the direction of the optical axis is generated in the focusing coil 8. This electromagnetic force moves the lens holder 2 in the direction of the optical axis while resiliently deforming the supporting members 5. Consequently, the objective lens 1 is moved in the direction of the optical axis, and focusing control is performed thereby.

At this time, since the boundary portions between the N pole 6n and the S poles 6s of the permanent magnet 6A are disposed on the opposite outer sides with respect to the opposite side edge portions of the center side yoke 7Ab in the radial direction, the number of magnetic fluxes from the N pole 6n to the yoke 7Ab is not extremely reduced particularly even on the opposite side portions, and as a result, the number of magnetic fluxes passing across the focusing coil 8 can be held substantially equal to that at the central portion. Incidentally, if the boundary portions between the N pole 6n and the S poles 6s are disposed on the inner sides with respect to the opposite side edge portions in the radial direction of the yoke 7Ab as seen in FIG. 8(b), then the magnetic fluxes at the opposite side portions of the N pole 6n are diverted away toward the opposite outer sides and the number of magnetic fluxes which pass through the focusing coil 8 decreases as much. Consequently, with the configuration of the permanent magnet 6A of the embodiment, the thrust for moving the lens holder 2 in the direction of the optical axis can be increased without increasing the power consumption.

Meanwhile, also the tracking coils 9 are disposed in the magnetic fields described hereinabove generated by the permanent magnets 6A and 6B, and if the tracking coils 9 (tracking coil elements 9a and 9b) on the opposite end faces of the lens holder 2 are energized, then electric currents flow in symmetrical directions as indicated by solid line arrow marks through the paired tracking coil elements 9a and 9b disposed in the radial direction as seen in FIG. 7. Then, when the electric currents are supplied to the tracking coil elements 9a and 9b wound in the rectangular (or square) configuration, the electric currents flow in the opposite directions in the upward and downward direction (direction of the optical axis) in the opposite sides h1 and h3 in the radial direction from among the four sides of the rectangular shape. Since the sides h1 and h3 are opposed to the N pole 6n and S poles 6s of the permanent magnet 6A, respectively, electromagnetic forces in the same radial direction as indicated by void arrow marks in FIG. 7 are generated in the sides h1 and h3 and move the lens holder 2 in the direction. This is equivalent between the paired tracking coil elements 9a and 9b, and this applies also to the paired tracking coil 9 on the opposite side opposing to the opposing permanent magnet 6B.

Since the permanent magnets 6A and 6B are magnetized so as to have three poles including the N pole 6n and the two S poles 6s and the paired tracking coil elements 9a and 9b directed in the radial direction are disposed in an opposing relationship to the boundaries between the three poles, electromagnetic forces acting in the same radial direction are generated in the two sides h1 and h3 of each of the tracking coil elements 9a and 9b. Conventionally, where a permanent magnet is formed with one pole, for example, the N pole, electromagnetic force generated in a radial direction in a tracking coil can be obtained from only one side of the tracking coil. However, with the configuration described above, electromagnetic force can be obtained from two sides of the tracking coil, and although it does not simply increase to twice, electromagnetic force proximate to twice can be obtained. Therefore, improvement of the electromagnetic force in the radial direction can be achieved without involving an increase of the scale of the coil configuration by an increase of the number of turns of the tracking coils 9 (tracking coil elements 9a and 9b) and without increasing the power consumption.

Further, since the permanent magnets 6A and 6B having three poles are used to significantly increase the electromagnetic force in the radial direction and besides each of the tracking coils 9 is formed from the two tracking coil elements 9a and 9b in the radial direction as described above, the effective length of the tracking coil elements 9a and 9b, that is, the dimension of the tracking coil elements 9a and 9b in the direction of the optical axis, can be reduced by an amount corresponding to the increased amount of the electromagnetic force within a range within which a desired level of electromagnetic force is satisfied. Further, by reducing the heightwise dimension of the tracking coil elements 9a and 9b, vibration by a rolling mode of the objective lens 1 can be prevented.

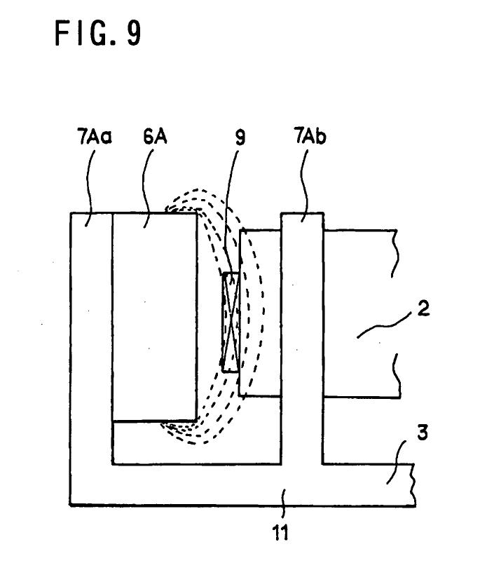

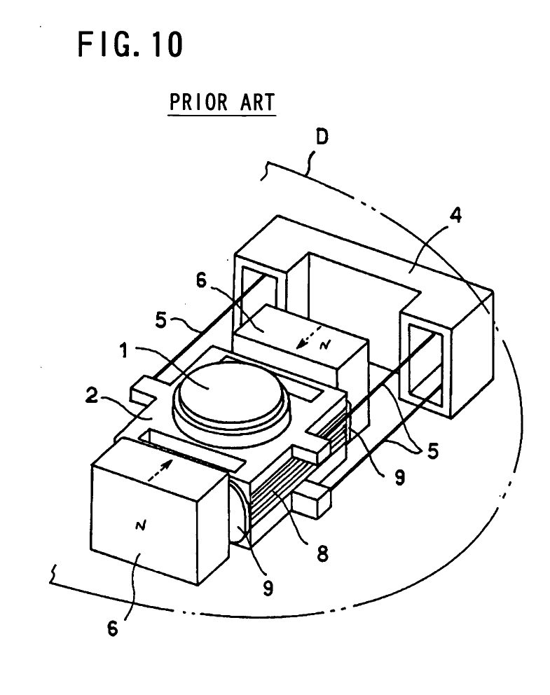

In particular, each of the paired permanent magnets 6A and 6B is configured such that the central N pole 6n and the opposite side S poles 6s continuously extend integrally in the direction of the axial direction, that is, in the heightwise direction. Besides, the lower side end faces of the permanent magnets 6A and 6B are spaced from the surface of the bottom wall 11 of the optical head base 3 and therefore are open similarly to the upper side end faces of the permanent magnets 6A and 6B. Therefore, as schematically shown in FIG. 9, the magnetic field formed by each of the permanent magnets 6A and 6B has a magnetic intensity distribution which is superior in upward and downward symmetry with the starting and ending points thereof defined by the opposite ends of the permanent magnets 6A and 6B. Furthermore, in the present embodiment, the effective length dimension of the tracking coils 9 (tracking coil elements 9a and 9b) in the direction of the optical axis is substantially equal to one half that of the permanent magnets 6A and 6B in the same direction, and besides, the tracking coils 9 are disposed in an opposing relationship at substantially central positions of the permanent magnets 6A and 6B in the same direction, respectively. Therefore, even if the objective lens 1 moves in the direction of the optical axis, each of the tracking coils 9 is moved within the range within which an almost entire part thereof moves within the range of the magnetic intensity distribution of the permanent magnets 6A and 6B which has a high degree of symmetry, and the center of the magnetic force generated in each of the tracking coils 9 is less likely to be fluctuated.

The rolling mode is a mode which occurs from a displacement between the center of gravity of the movable part, that is, the lens holder 2 including the objective lens 1, and the central point of the electromagnetic force generated in the radial direction. Therefore, even if the objective lens 1 moves in the direction of the optical axis to change the position of the tracking coils 9 in the direction of the optical axis as described above, the center of the magnetic force generated is less likely to be fluctuated in the direction of the optical axis, and consequently, vibration by the rolling mode is less likely to appear with the lens holder 2. Incidentally, if the lower side end portions of the permanent magnets 6A and 6B are held in contact with the optical head base 3, then the magnetic intensity distribution includes the optical head base 3 in the proximity of the lower side end portions of the permanent magnets 6A and 6B, and therefore, the symmetry described above is lost and the rolling mode suppression effect is deteriorated.

Thus, with the objective lens driving apparatus of the embodiment of the present invention described above, the thrusts in the direction of the optical axis and the radial direction, or in other words, the thrusts in the focusing direction and the tracking direction, can be improved simultaneously without increasing the power consumption. Besides, even if the focused position of the objective lens is shifted in order to cope with a different type of a medium, resonance by the rolling mode of the movable part can be suppressed, and good information recording and reproduction characteristics can be achieved.

It is to be noted that, even if the magnetization polarities of the permanent magnets between the N pole and the S pole are reversed to those of the embodiment, similar effects can naturally be achieved. Further, even if a plurality of magnets are adhered integrally in place of a permanent magnet having multiple poles, similar effects can be achieved. Furthermore, even if the objective lens driving apparatus is configured so as to drive the optical head not only in the focusing and tracking directions but also in a tangential direction, similar effects can be achieved.

While a preferred embodiment of the present invention has been described using specific terms, such description is for illustrative purposes only, and it is to be understood that changes and variations may be made without departing from the spirit or scope of the following claims.

1. An objective lens driving apparatus for an optical head, comprising:
a rockable lens holder on which an objective lens for condensing light from a light source on an optical disk medium, a focusing coil for driving said objective lens in a direction of an optical axis of said objective lens and a tracking coil for driving said objective lens in a radial direction perpendicular to the optical axis are carried; and
a magnet for cooperating with said focusing coil and said tracking coil to generate electromagnetic forces in the direction of the optical axis and the radial direction;
said magnet having a first magnetic pole centrally located thereon along the radial direction and a pair of second magnetic poles having a different polarity from that of said first magnetic pole and located on the opposite sides of said first magnetic pole;
said tracking coil including a pair of elements disposed separately in the radial direction in an opposing relationship to both of said first and second magnetic poles at boundary portions between said first and second magnetic poles of said magnet.

2. An objective lens driving apparatus for an optical head as claimed in claim 1, wherein said first magnetic pole of said magnet has a dimension in the radial direction greater than the dimension in the radial direction of a yoke disposed in an opposing relationship across said focusing coil, and said second magnetic poles on the opposite sides of said first magnetic pole are positioned on the outer sides with respect to the opposite side edges of said yoke in the radial direction.

3. An objective lens driving apparatus for an optical head as claimed in claim 1, wherein each of said second magnetic poles of said magnet in the radial direction has a dimension smaller than the dimension of said first magnetic coil in the radial direction, and said elements of said tracking coil opposing to said second magnetic poles have a second opposing area smaller than a first opposing area of said elements of said tracking coil opposing to said first magnetic pole.

4. An objective lens driving apparatus for an optical head as claimed in claim 1, wherein said elements of said tracking coil are wound in a substantially quadrangular shape, and the two opposite sides from among the four sides of said elements of said tracking coil which extend in the direction of the optical axis are opposed to said first and second magnetic poles of said magnet.

5. An objective lens driving apparatus for an optical head as claimed in claim 1, wherein said magnet is open at the opposite end faces thereof in the direction of the optical axis.

6. An objective lens driving apparatus for an optical head as claimed in claim 5, wherein said tracking coil is disposed in an opposing relationship to a substantially central position of said magnet in the direction of the optical axis.

7. An objective lens driving apparatus for an optical head as claimed in claim 1, wherein said magnet has a dimension in the direction of the optical axis equal to or greater than twice an effective length dimension of a portion of said tracking coil which extends in a direction parallel to the direction of the optical axis.

8. An objective lens driving apparatus for an optical head as claimed in claim 1, wherein said magnet is formed from a single magnetic member magnetized so as to have said first and second magnetic poles.

9. An objective lens driving apparatus for an optical head as claimed in claim 1, wherein said magnet is formed from a plurality of magnetic pieces integrated with each other and magnetized so as to have said first and second magnetic poles.
